(19) United States
(12) Patent Application Publication
(10) Pub. No.: US 2007/0001017 A1
(43) Pub. Date: Jan. 4, 2007

(54) Reduced complexity multifunction expansion card and method of operating the same

(76) Inventors: Moshe Nuri, Shoham (IL); Reuven Konevky, Tzur Yigal (IL); Shimon M. Krausz, Rehovot (IL); Eitan Kugman, Petah Tikva (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/170,367

(22) Filed: Jun. 29, 2005

(51) Int. Cl. G06K 19/06

(52) U.S. Cl. 235/492

(57) ABSTRACT

A multifunction expansion card (200) comprises a MUX/DEMUX (206) for selectively coupling either a first PCMCIA module (208) or a second PCMCIA module (210) to a card connector (202). A microcontroller (238) controls the MUX/DEMUX (206) and an optoisolator (224) which is used to selectively couple a first card detect pin CD1 to a ground plane (236) of the card (200). Switching between modules is initiated by a host (100), to which the card (200) is connected, setting an interrupt of the microcontroller (238). In servicing such interrupts the microcontroller (238) changes a data select input (254) of the MUX/DEMUX (206) and temporarily decouples the first card detect pin CD1 in order to simulate unplugging and replugging of the card (200) and thereby initiate a process of reinitialization of a host bus adapter (106) and the card (200) by card enabler software (110) of the host (100).

### FIELD OF THE INVENTION

The present invention relates generally to expansion bus cards. More particularly the present invention relates to multifunction expansion bus cards

### BACKGROUND

The advent of the personal computer brought the impact of the information age directly to the populace at large. One feature that made the personal computer the great success that it has been is the provision of an expansion bus which allows for augmenting the functionality of personal computers by adding hardware such as sound cards, high performance video cards, and various types of data communication hardware. The expansion bus allows hardware to be upgraded and functionality to be added without having to replace the entire computer.

Laptop personal computers make computer use even more convenient by allowing computers to be taken wherever their owner might require their use. Students and business travelers especially benefit from laptop portability. As laptop computers became more popular, the need for an expansion bus for laptops computers became evident. To meet this need the Personal Computer Memory Card International Association (PCMCIA) card standard was developed. A variety of types of cards including Ethernet network interfaces, dial up modems, memory cards were developed using the PCMCIA card standard.

In order to increase the functionality of laptop computers without increasing there size (so as to maintain user convenience) it is desirable to provide PCMCIA cards that have two or more functions in a single PCMCIA card. The PCMCIA standard itself contemplates a logical design of multiple function PCMCIA card involving, inter alia, a super Card Information Structure (CIS) that mediates and allows transitioning between the multiple functions. However, such a logical design suggests a tightly integrated electronic designs for the two circuits. Designing a tightly integrated electronic multifunctional PCMCIA circuit requires a large investment of human resources and time. Given the rapid pace at which technical developments need to reach the market in order to be competitive, long delays and expenditures are undesirable. It would be desirable to provide multifunction PCMCIA cards that use available single function PCMCIA integrated circuits or IP cores, and require a limited amount of additional circuitry to mediate between multiple functions.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a host system for use with PCMCIA cards in accordance with some embodiments of the invention;

FIG. 2 is an example of a multifunction PCMCIA card in accordance with some embodiments of the invention;

FIG. 3 is a first flowchart showing the operation of a PCMCIA card enabler program of the host shown in FIG. 1 in accordance with some embodiments of the invention;

FIG. 4 is a second flowchart showing the operation of a software application program that runs on the host shown in FIG. 1 and that uses multiple functions of the multifunction PCMCIA card in accordance with some embodiments of the invention; and

FIG. 5 is a third flowchart showing the operation of the multifunction PCMCIA card.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to improved multifunction PCMCIA cards. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of improved multifunction PCMCIA cards described herein. The non-processor circuits may include, but are not limited to, a radio receiver, a radio transmitter, signal drivers, clock circuits, power source circuits, and user input devices. As such, these functions may be interpreted as steps of a method to perform improved multifunction PCMCIA cards. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

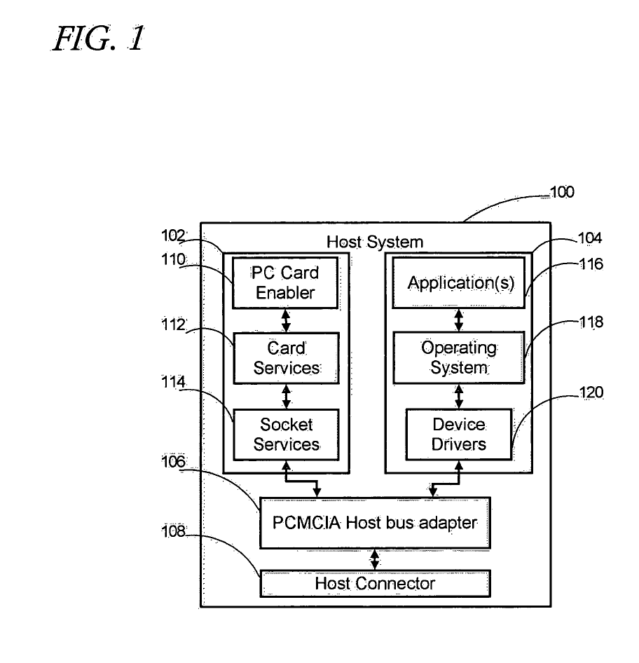

FIG. 1 is an example of a host system 100 for use with PCMCIA cards in accordance with some embodiments of the invention. The host system 100 comprises a first software stack 102, a second software stack 104, a host bus adaptor 106 and a host connector 108.

The first software stack 102 is responsible for low-level configuration of the host bus adaptor 106. The first software stack 102 comprises a PC card enabler program 110, a card services program 112, and a socket services program 114. The PC card enabler program 110, uses the card services program 112 which in turn uses the socket services program 114 to configure the host bus adaptor 106.

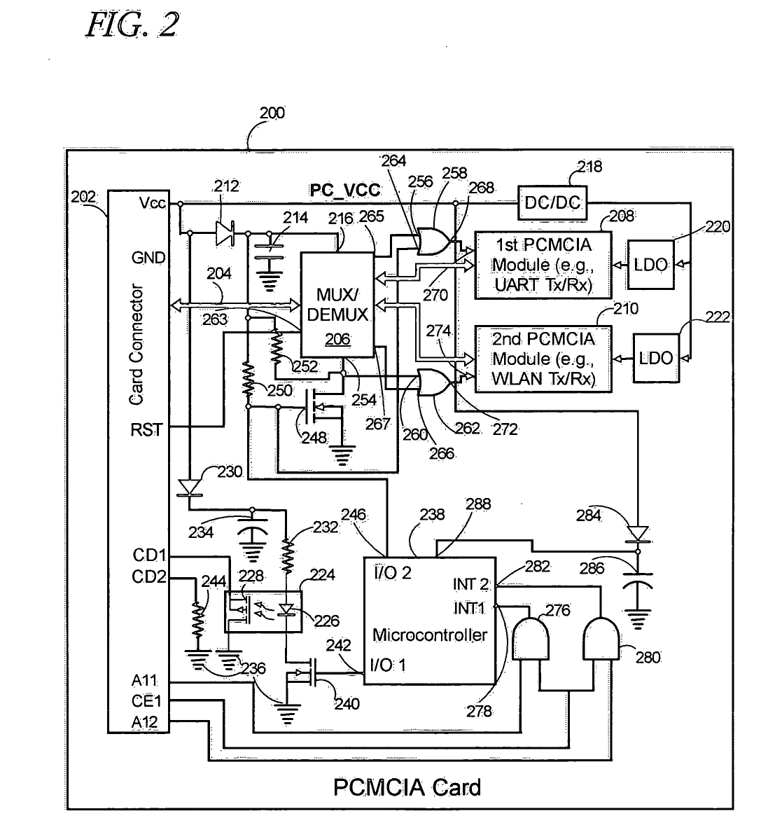

The host bus adaptor 106 is coupled to the host connector 108. The host connector 108 is designed to connect with PCMCIA cards. When a PCMCIA card (e.g., 200, FIG. 2) is plugged into the connector 108, the host bus adaptor 106 will detect the PCMCIA card (as described more fully below) and in response to detecting the PCMCIA card will trigger an interrupt which will be hooked to the first software stack 102. As part of a process of servicing the interrupt, the first software stack 102 will configure the host bus adaptor 106 for the PCMCIA card and allocate resources of the host 100 for the PCMCIA card. The configuring of the host bus adaptor 106 and allocation of resources is in accordance with data known as a Card Information Structure that is stored in the PCMCIA card.

The second software stack 104 comprises an application program 116, an operating system 118, and device drivers 120. Once the host bus adaptor 106 has been configured by the first software stack 102, the application program 116 is able to access memory and/or functionality (e.g., network interfaces) on the PCMCIA card through the operating system 118, device drivers 120, and the host bus adaptor 106. The application program 116 need not interact with the PC card enabler program 110.

FIG. 2 is an example of a multifunction PCMCIA card 200 in accordance with some embodiments of the invention. The PCMCIA card 200 has a card connector 202, that has a voltage supply pin (labeled Vcc), a ground pin (labeled GND), a reset pin (labeled RST), a first card detection pin (labeled CD1), a second card detection pin (labeled CD2), a first address pin (labeled A11), a second address pin (labeled A12), a card enable pin (labeled CE1), and a number of remaining pins 204. The remaining pins 204 are specified in PCMCIA card standards. The remaining pins 204 are coupled through a multiplexer-demultiplexer (MUX/DEMUX) 206 to either a first PCMCIA module 208 or a second PCMCIA module 210. The first PCMCIA module 208 may, for example, comprise a Universal Asynchronous Receiver Transmitter (UART) and the second PCMCIA module 210 may, for example, comprise a WLAN module. The PCMCIA modules 208, 210 suitably take the form of Application Specific Integrated Circuits (ASIC) or IP cores. The multifunction PCMCIA card 200 is able to incorporate previously designed single function PCMCIA ASICs or IP cores. Thus, the card 200 thus provides an inexpensive design solution for providing multiple functions in a single PCMCIA card.

The voltage supply pin Vcc is coupled through a first diode 212 to a first capacitor 214. The first capacitor 214 is coupled to a MUX/DEMUX voltage supply pin 216 so as to supply voltage to the MUX/DEMUX 206. The voltage supply pin Vcc is also coupled to a DC-to-DC converter 218. The DC-to-DC converter 218 supplies voltage through a first low drop out voltage regulator 220 to the first PCMCIA module 208 and through a second low drop out voltage regulator 222 to the second PCMCIA module 210.

The multifunction PCMCIA card 200 also has a switch, in particular an optoisolator 224. The optoisolator 224 comprises a photodiode 226 for producing light in response to an electrical signal and a phototransistor 228 for producing an electrical signal in response to light from the photodiode 226. The voltage supply pin Vcc of the card connector 202 is also coupled through a second diode 230, and a current limiting resistor 232 to the anode of the photodiode 226. A second capacitor 234 is coupled between a junction of the second diode 230 and the current limiting resistor 232 and a ground plane 236 of the card 200. The second capacitor 234 serves to supply voltage to the photodiode 226 when the host system 100 cuts off power to the voltage supply pin Vcc of the card 200. The phototransistor 228 of the optoisolator 224 connects the first card detect pin CD1 to the ground plane 236 of the card 200.

The multifunction PCMCIA card 200 also has a microcontroller 238 and a first transistor 240 that are arranged to control the photodiode 226. The microcontroller 238 has a first input-output (I/O) pin 242 that is coupled to the gate of the first transistor 240. The drain of the first transistor 240 is coupled to the cathode of the photodiode 226 of the optoisolator 224. The source of the first transistor 240 is coupled to the ground plane 236 of the card 200. By controlling a signal applied through the first I/O pin 242 to the gate of the first transistor 240, the microcontroller 238 can control the state of the first transistor 240 which in turn controls the state of the optoisolator 224. Thus the microcontroller 238 is able to selectively ground the first card detect pin CD1. In operation, when the card connector 202 is plugged into the host connector 108, the host 100 will apply a voltage to the first card detect pin CD1 through a pull-up resistor (not shown) in the host bus adaptor 106. Standard PCMCIA cards are detected when the host bus adaptor 106 detects that the voltage on a host connector 108 pin (not shown) that mates with the card detect pin CD1 is below a predetermined threshold (meaning that the mating pin has been grounded through the standard PCMCIA card). In the case of the multifunction PCMCIA card 200 shown in FIG. 2, by selectively decoupling the first card detect pin CD1 from ground 236 using the optoisolator 224, unplugging of the PCMCIA card 200 is simulated in order to cause the host bus adaptor 106 to trigger an interrupt in the host 100, reinitialize the card 200 and reallocate host resources for the card 200. Triggering the host 100 reinitialization and reallocation in combination with internal reconfiguration of the card 200 described below allows operation to be switched between two or more separate internal PCMCIA modules (e.g. 208, 210) that are in the card 200. The second card detect pin CD2 is coupled through a biasing resistor 244 to the ground plane 236 as in a standard PCMCIA card. Alternatively, the second card detect pin CD2 is also coupled to the ground plane 238 through the optoisolator 224 or a separate optoisolator (not shown).

A second I/O pin 246 of the microcontroller 238 is coupled to the gate of a second transistor 248. A gate biasing resistor 250 is coupled between the first capacitor 214 and the gate of the second transistor 248. A pull-up resistor 252 is coupled between the first capacitor 242 and the drain of the second transistor 248. The drain of the second transistor 248 is coupled to a data select input 254 of the MUX/DEMUX 206. The gate of the second transistor 248 is coupled to a first gate input 256 of a first OR gate 258. The drain of the second transistor 248 is coupled to a first gate input 60 of a second OR gate 262. The biasing and design of the second transistor 248 is such that the logic states of the signals at the gate and drain of the second transistor 248 will have an inverse relation to each other. In other words, the second transistor 248 serves as an inverter so that the signal applied to the first gate input 256 of the first OR gate 258 and the signal applied to the first gate input 260 of the second OR gate 262 will have an inverse relationship. The reset pin RST of the card connector 202 is coupled to a reset signal input 263 of the MUX/DEMUX 206. The MUX/DEMUX couples the reset signal input 262 to either a first reset signal output 265 or a second reset signal output 267 of the MUX/DEMUX 206 depending on the state of the data select input 254. The first reset signal output 265 of the MUX/DEMUX 206 is coupled to a second gate input 264 of the first OR gate 258 and the first reset signal output 267 of the MUX/DEMUX 206 is coupled to a second gate input 266 of the second OR gate 262. A gate output 268 of the first OR gate 258 is coupled to a reset input 270 of the first PCMCIA module 208. Similarly, a gate output 272 of the second OR gate 262 is coupled to a reset input 274 of the second PCMCIA module 210. In as much as the first gate inputs 256, 260 of the OR gates 258, 262 are driven by the gate and drain of the second transistor 248 (which have inverse signal states), at any time, at least one of the outputs 268, 272 of the OR gates 258 262 will be high.

A signal from the second I/O pin 246 of the microcontroller 238 controls the second transistor 248 and thereby controls a signal state applied to the data select input 254 of the MUX/DEMUX 206 and controls which of the OR gates 258 262 output 268, 272 will be held high. The state of the data select input 254 determines which of the PCMCIA modules 208, 210 will be coupled to the host 100 through the remaining pins 204 of the card connector 202.

According to the PCMCIA standard, in order to reset a PCMCIA card t the reset pin RST is driven high by the host for an interval of time and then released. In the multifunction PCMCIA card 200 shown in FIG. 2 the reset signal is coupled from the reset pin RST of the card connector 202 through the MUX/DEMUX 206 and through the OR gates 258, 262 to the PCMCIA modules 208, 210. However, at any given time one of the OR gates (258 or 262) coupled to one of the PCMCIA modules (208 or 210) which is deselected will have receive a steady logic high signal from the gate or drain of the second transistor 248. Holding the reset input (270 or 274) of the deselected PCMCIA module high will prevent that module from going into normal operating mode. When the state of the signal applied to the second transistor 248 is such that the state of data select input 254 of the MUX/DEMUX 206 configures the MUX/DEMUX 206 to route signals to and from one of the PCMCIA modules (208 or 210), the OR gate (262 or 258) coupled to the reset input (270 or 274) of the other of the PCMCIA modules (210 or 208) will receive a steady logic high signal from the drain or gate of the second transistor 248.

The first address pin A11 and the card enable pin CE1 of the card connector 202 are coupled to individual inputs of a first AND gate 276. The output of the first AND gate 276 is coupled to a first interrupt pin 278 of the microcontroller 238. Similarly, the second address pin Al 2 and the card enable pin CE1 are coupled to individual inputs of a second AND gate 280 and the output of the second AND gate 280 is coupled to a second interrupt pin 282 of the microcontroller 238. The foregoing arrangement of the first AND gate 276 and the second AND gate 280 allows the microcontroller 238 to be interrupted by the host 100. In particular the application program 116 can set a first interrupt of the microcontroller 238 through the host bus adaptor 106 by accessing a memory location that is mapped to the first address pin A11 and can set a second interrupt of the microcontroller 238 by accessing a memory location that is mapped to the second address pin A12.

In servicing both the first interrupt and the second interrupt, the microcontroller 238 will operate the optoisolator 224 in order to decouple the first card detect pin CD1 from the ground plane 236 so as to simulate to the host 100 that the card 200 has been disconnected. In response the host 100 will reinitialize the card 200 and reallocate resources for the card 200 in the host 100. In servicing the first interrupt, the microcontroller 238 sets the signal state of second I/O pin 246 in order to switch the MUX/DEMUX 206 from the first PCMCIA module 208 to the second PCMCIA module 210 and set the reset input 270 of the first PCMCIA module 208 to a state that holds the first PCMCIA module 208 in an inactive reset state. On the other hand, in servicing the second interrupt the microcontroller 238 will set the signal state of the second I/O pin 246 in order to switch the MUX/DEMUX 206 from the second PCMCIA module 210 to the first PCMCIA module 208 and set the reset input 274 of the second PCMCIA module 210 to a state that holds the second PCMCIA module 210 in an inactive state.

The voltage supply pin Vcc of the card connector 202 is also coupled through a third diode 284 to a third capacitor 286. A voltage supply pin 288 of the microcontroller 238 is coupled to the third capacitor 286. When the optoisolator 224 decouples the first card detect pin CD1 from the ground plane 236 to simulate unplugging of the card 200, the host 100 will respond by cutting power to the voltage supply pin Vcc. The arrangements of diodes 212, 230, 284 and capacitors 214, 234, 286 serve to maintain power for the MUX/DEMUX 206, optoisolator 224, and microcontroller 238 while the power is cut. The microcontroller 238 suitably has a low power mode that is invoked while the first card detect pin CD1 is decoupled from the ground plane 236, and the host 100 has cut power to the voltage supply pin Vcc.

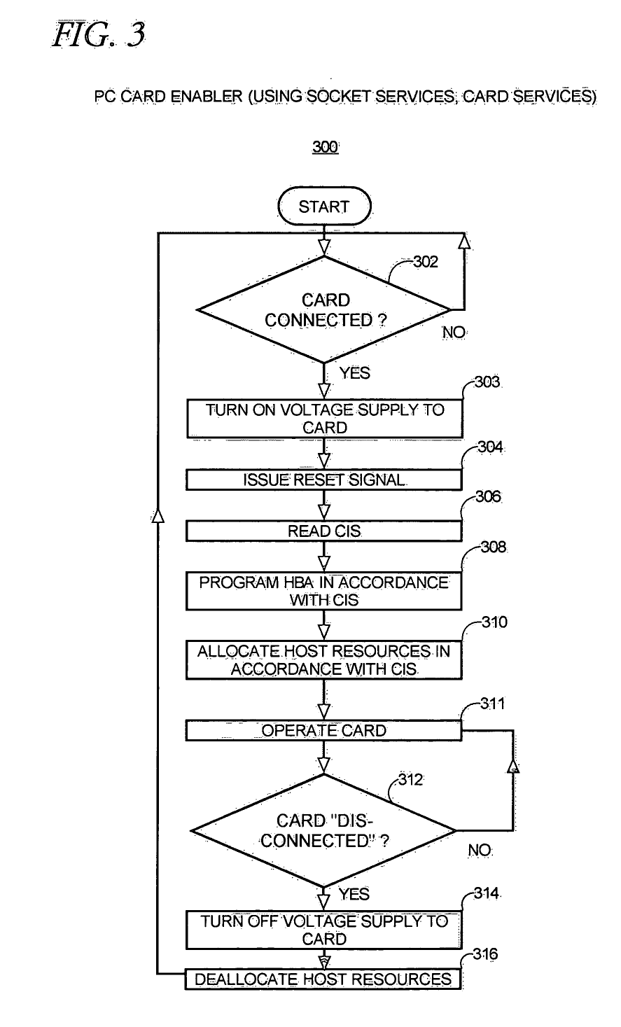

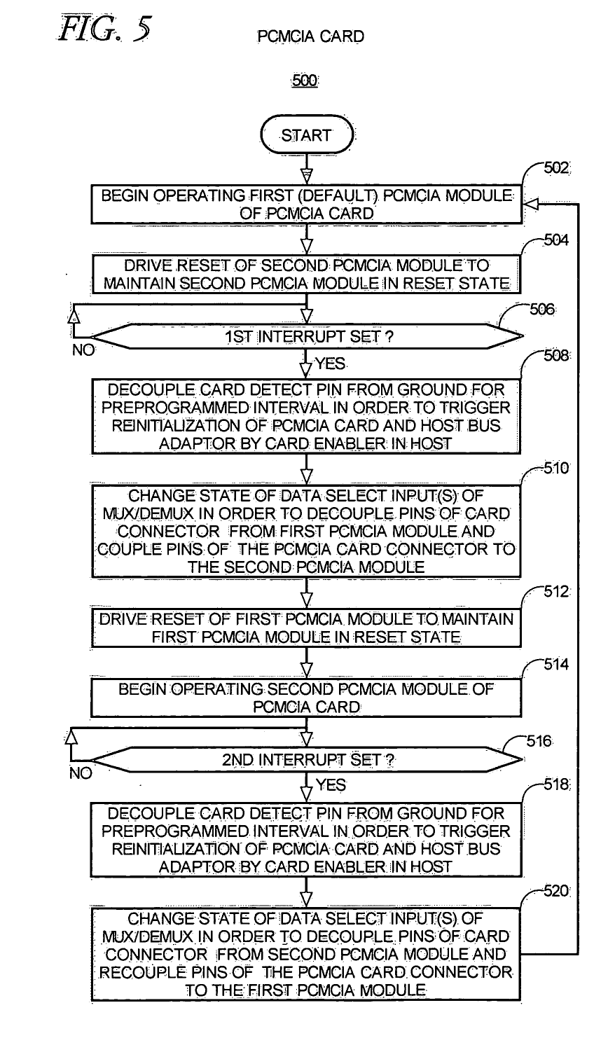

FIG. 3 is a first flowchart 300 showing the operation of a PCMCIA card enabler program 110 of the host 100 in accordance with some embodiments of the invention. The operation depicted in the first flowchart commences when the host 100 is turned on. Initially, decision block 302 determines if the card 200 is “connected” to the host 100. Connection of the card 200 is detected using the first card detect pin CD1 and the second card detect pin CD2. As noted above the card 200 is able to simulate disconnection using the optoisolator 224. If it is determined in block 302 that the card is “disconnected” the flowchart proceeds to block 303 in which the voltage supply to the card is turned on. Then in block 304 a reset signal is sent to the card 200. After a predetermined delay, in block 306 the host 100 will read the CIS. The CIS includes information needed to configure the host bus adapter 106 and allocate resources on the host 100 for the card 200. Each of the two PCMCIA modules 208, 210 has its own CIS. Which CIS is read in block 306 depends on the state of the MUX/DEMUX 206 when block 306 is executed. The programming of the microcontroller 238 (as described below with reference to FIG. 5) is such that the card 200 starts in a default state with the MUX/DEMUX 206 configured to select the first PCMCIA module 208. In block 308 the host bus adaptor 106 is configured in accordance with information stored in the CIS, and in block 310 resources on the host 100 are allocated in accordance with information stored in the CIS. Block 311 represents operation of the card 200 as a peripheral of the host 100. Block 312 is a decision block, the outcome of which depends on whether the card 200 is “disconnected” (including simulated disconnection using the optoisolator 224). If it is determined in block 312 that the card 200 is “disconnected”, then in block 314 the voltage supply to the card 200 is turned off. Then in Block 316 resources that were allocated in the host 100 for the card 200 are deallocated. Thereafter, the flowchart 302 returns to block 302 to await “connection” (including recoupling the first card detect pin CD1 to the ground plane 236 by the optoisolator 224).

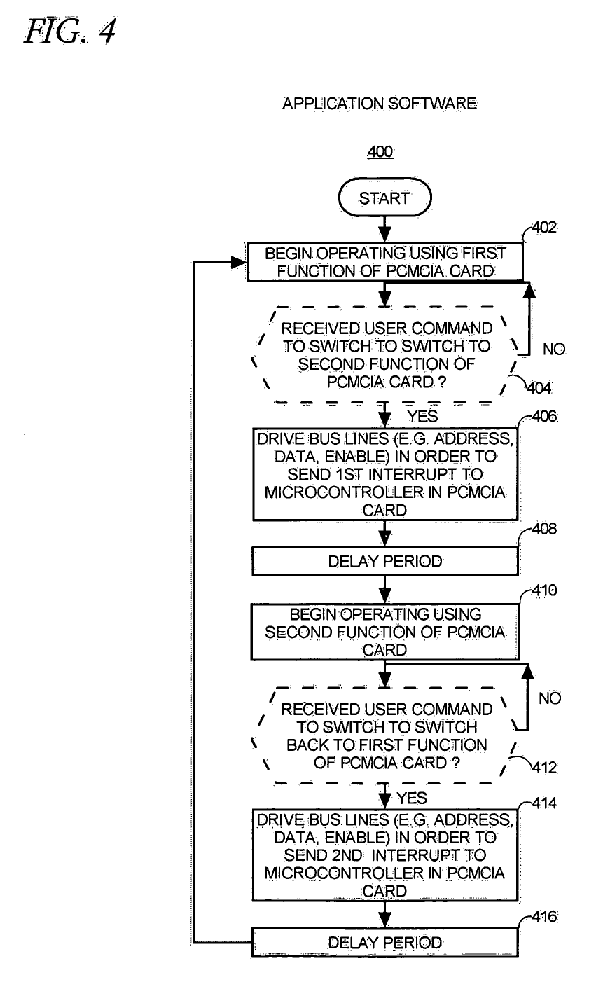

FIG. 4 is a second flowchart 400 showing the operation of the software application program 116 that runs on the host shown in FIG. 1 and that uses multiple functions of the multifunction PCMCIA card 200 in accordance with some embodiments of the invention. Although the application program 116 need not communicate with the PCMCIA card enabler program 110, the application program 116 works in concert with the PCMCIA card enabler program 110. In block 402 the application program 116 begins operating using the first function (i.e., the function performed by the first PCMCIA module 208). Block 404 is a decision block the outcome of which depends on whether a user command to switch to a second function (i.e., the function performed by the second PCMCIA module 210) of the PCMCIA card 200 is received. The user command is suitably entered through a Graphical User Interface (GUI) of the application program 116. Alternatively, other command input means could be used. (Alternatively, switching to the second function is automatic and is not contingent on user input.) When the user command to switch to the second function of the PCMCIA card is received the flowchart 400 continues with block 406 in which bus lines of the host 100 which are mapped by the host bus adapter 106 to the first address pin A11 are driven in order to set the first interrupt of the microcontroller 238. After a delay period 408 that includes a first subperiod for which the optoisolator 224 decouples the first card detect pin CD1 in order to set a host interrupt through the host bus adaptor 406 that triggers blocks 314, 316, and a second subperiod sufficient to perform blocks 304, 306, 308, 310, the flowchart 400 continues with block 410 in which the application program begins using the second function of the PCMCIA card. (During the delay period 408, the MUX/DEMUX 206 will have decoupled the remaining pins 204 of the card connector 202 from the first PCMCIA module 208 and coupled them to the second PCMCIA module 210.) Block 412 is a decision block the outcome of which depends on whether a user command to switch back to the first function of the PCMCIA module is received. (Switching back can also be automatically controlled by the application program 400, and not contingent on user input). When a user command to switch back to the first function is received, the flowchart 400 continues with block 414 in which bus lines of the host 100 which are mapped by the host bus adapter 106 to the second address pin Al 2 are driven in order to set the second interrupt of the microcontroller 238. After a delay period 416 which is analogous to the delay period 408 the flowchart proceeds to block 402 in which the application program 116 begins operating using the first function of the PCMCIA card again.

FIG. 5 is a third flowchart 400 showing the operation of the multifunction PCMCIA card 200. In block 502 the card 200 begins operating in the first PCMCIA module 208 and in block 504 the reset input 274 of the second PCMCIA module 210 is driven to maintain the second PCMCIA module 210 in an inactive reset state. Blocks 208 and 210 are suitably performed concurrently. Block 506 is a decision block which depends on whether the first interrupt of the microcontroller 238 has been set. If so then in block 508 first card detect pin CD1 is decoupled from the ground plane 236 for a preprogrammed interval in order to trigger reinitialization of the card 200 and the host bus adaptor 106 by the card enabler program 110. Then in block 510 the state of data select input 254 of the MUX/DEMUX is changed in order to decouple the remaining pins 204 of the card connector 202 from the first PCMCIA module 208 and couple the remaining pins 204 of the card connector 202 to the second PCMCIA module 210. In block 512 the reset input 270 of the first PCMCIA module 208 is driven to maintain the first PCMCIA module 208 in an inactive reset state. In block 514 the second PCMCIA module 510 begins operating.

Block 516 is a decision block that depends on whether the second interrupt of the microcontroller 238 has been set. If so then in block 518 the first card detect pin CD1 is again decoupled from the ground plane 236 for a preprogrammed interval in order to trigger reinitialization of the card 200 and the host bus adaptor 106 by the card enabler program 110. Then in block 520 the state of data select input 254 of the MUX/DEMUX 206 is changed in order to decouple the remaining pins 204 of the card connector 202 from the second PCMCIA module 210 and recouple the remaining pins 204 of the card connector 202 to the first PCMCIA module 208. Thereafter the flowchart returns to block 502 and proceeds as described above.

Although, the method shown in FIG. 5 has been described above with reference to the hardware shown in FIG.2, it is noted that the method shown in FIG. 5 is applicable to multifunction PCMCIA cards having hardware that departs from what is shown in FIG. 2.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An expansion card comprising:
a ground plane;
an expansion card connector comprising a card detect pin;
a switch coupled between said ground plane and said card detect pin;
a first circuit having a first functionality;
a second circuit having a second functionality;
a multiplexer/demultiplexer coupled to said first circuit, to said second circuit and to said expansion card connector, said multiplexer/demultiplexer comprising a data select input, wherein said multiplexer/demultiplexer is adapted to coupled either first circuit or said second circuit to said card connector in response to a signal applied at said data select input;
a microprocessor coupled to said data select input and said switch, said microprocessor comprising a first interrupt input, wherein said microprocessor is programmed to respond to a first interrupt signal received at said first interrupt input by changing a state of said switch for a predetermined period of time and changing said signal applied to said data select input.

2. The expansion card according to claim 1 comprising:
a PCMCIA card.

3. The expansion card according to claim 1 wherein:
said first circuit comprises a first transceiver; and
said second circuit comprises a second transceiver.

4. The expansion card according to claim 1 wherein:
said first circuit comprises a WLAN transceiver; and
said second circuit comprises a UART transceiver.

5. The expansion card according to claim 1 wherein:
said first circuit comprises an first reset input; and
said microprocessor is coupled to said first reset input and said microprocessor is further programmed to hold said first reset at a predetermined logic level in response to said first interrupt signal.

6. The expansion card according to claim 5 wherein:
said second circuit comprises a second reset input and said microprocessor is coupled to said second reset input; and
said multiplexer/demultiplexer comprises a first reset signal output and a second reset signal output;
and said expansion card further comprises a third circuit comprising:
an inverter comprising an inverter input coupled to said microprocessor and an inverter output;
a first logic gate comprising a first logic gate input coupled to said microprocessor, a second logic gate input coupled to said first reset signal output, and a first logic gate output coupled to said first reset input;
a second logic gate comprising a third logic gate input coupled to said inverter output, a fourth logic gate input coupled to said second reset signal output and a second logic gate output coupled to said second reset input.

7. The expansion card according to claim 6 wherein said inverter comprises a transistor.

8. The expansion card according to claim 6 wherein:
said first logic gate comprises an OR gate; and
said second logic gate comprises an OR gate.

9. The expansion card according to claim 1 wherein:
said first circuit consists of a first integrated circuit; and
said second circuit consists of a second integrated circuit.

10. The expansion card according to claim 1 wherein:
said switch comprises an optoisolator.

11. The expansion card according to claim 1 wherein:
wherein said first interrupt input is coupled to said expansion card connector.

12. A method of switching between two PCMCIA circuits that are present in a single PCMCIA card, the method comprising:
while operating a first PCMCIA circuit, receiving an interrupt;
in response to said interrupt, changing a signal level on a card detect pin for a predetermined period of time;
during said predetermined period of time, decoupling said first PCMCIA circuit from a connector of said single PCMCIA card and coupling a second PCMCIA circuit to said connector; and
operating said second PCMCIA circuit.

13. The method according to claim 12 wherein changing said signal level on said card detect pin for said predetermined period of time comprises disconnecting said card detect pin from a ground plane.

14. The method according to claim 12 further comprising:
after said predetermined period of time holding said first PCMCIA circuit in a reset state.
